(19) United States
(12) Patent Application Publication
(10) Pub. No.: US 2015/0379437 A1
(43) Pub. Date: Dec. 31, 2015

(54) METHOD AND SYSTEM FOR ON-DEMAND TRANSPORTATION SERVICES

(71) Applicant: Ford Global Technologies, LLC, Dearborn, MI (US)

(72) Inventor: Daniel Reich, Royal Oak, MI (US)

(73) Assignee: Ford Global Technologies, LLC, Dearborn, MI (US)

(21) Appl. No.: 14/709,753

(22) Filed: May 12, 2015

Related U.S. Application Data
(60) Provisional application No. 62/017,484, filed on Jun. 26, 2014.

(51) Int. Cl. G06Q 10/02

(52) U.S. Cl. CPC G06Q 10/02; G06Q 50/30

(57) ABSTRACT

Data relating to travel of a plurality of users, including destinations of the plurality of users and flight arrival delay data, are received. The plurality of users are assigned to a plurality of groups based on the data. An on-demand transport shareable by a selected group is identified based at least in part on the data, The on-demand transport is initiated for the selected group.

### RELATED APPLICATION

This application claims priority to U.S. Provisional Application Ser. No. 62/017,484 filed Jun. 26, 2014, which is hereby incorporated herein by reference in its entirety.

### BACKGROUND

Vehicles such as personal vehicles and dedicated taxis generally provide a very flexible form of transportation for commuters and passengers within urban environments. However, in addition to being expensive, such vehicles increase congestion and pollution. Public transit systems, including buses, trains, subways, etc., that operate on a fixed schedule, are an alternate, and generally lower-cost, option for commuters. Shared transportation options reduce in-city congestion and improve air quality. However, a commuter on shared transportation typically has less flexibility in terms of departure and arrival times.

Another shared transportation option that provides a good mix of flexibility, cost, ease of use, and environmental impact is transportation service that may be shared amongst users and provided according to user demands or requests. Unfortunately, mechanisms for managing on-demand systems are lacking.

### BRIEF DESCRIPTION OF THE DRAWINGS

FIG. 1 is a block diagram of the system for on demand transportation services.

FIG. 2 is a block diagram of a method for on demand transportation services.

FIG. 3 is an exemplary view of the system for on demand transportation services.

### DETAILED DESCRIPTION

On-demand transportation services may be used to simplify travel services. For example, an on-demand shuttle service may operate along a route that is adjusted based on the commuters requesting the service. Therein, a group of commuters from a common origin, or origins that are proximate to each other, may request to be transported to a common destination, or destinations proximate to each other. The shared ride reduces their commute cost while also reducing in city congestion and pollution. At the same time, the schedule and route is determined by the commuters, increasing flexibility.

In one example, on-demand transportation services may be used by service providers such as hotel service providers as well as airline service providers to provide transportation services to their customers. In addition, an exemplary on-demand transportation service may be used as a leg in a multi-leg trip, e.g., as a branch or mode in a passenger's multi modal transportation trip, i.e., a trip including multiple modes of transport, such as a car, a bus, a train, and/or a taxi, etc. Connecting a group of users on to a common on-demand shuttle from a common alternate mode of transportation may provide for more convenient and/or efficient conveyance of users. For example, a user's transfer between different modes of transportation may be coordinated and synchronized to improve usage of shared transportation options even if a user requests a shared transportation service, but due to time constraints and travel delays from an alternate mode of transportation, is not able to obtain a requested ride at a time when scheduled shared transportation, e.g., a city bus, would be available.

As an example, passengers headed to a common hotel from a common bus terminal or airplane terminal may be grouped together so that they can share a common on-demand shuttle or the like from the terminal to the hotel. Hotels partnered with the on-demand shuttle service may refer to a roster of users arriving on a given day from the common terminal (e.g., a common airplane terminal or common bus terminal or common train terminal). Users may be further grouped based on arrival on a common flight or arrival on different flights within a threshold duration of each other (e.g., within 20 minutes of each other). By grouping users arriving on a common flight, on-demand transportation schedules can be more easily adjusted based on changes or delays in the schedule of the incoming flight. The user grouping data may be shared with a central server (e.g., over a network, or via a remote server) of the on-demand transportation service provider and used to request an on-demand shuttle service. For example, flight arrival time(s) may be used to schedule an on-demand transportation service pick-up time, and/or a number of hotel users arriving on a given flight may be used to request a size or capacity of a shared transportation vehicle. The data may also be shared with a transportation provider, e.g., an airline (or bus or train) service provider.

Further, scheduled transportation service providers, e.g., airlines (or bus or train services providers) partnered with a shared transportation service such as on-demand shuttle service, may alternatively or additionally group users based on a common presence at or near a location at or around a given time. For example, a group of such users may be scheduled to arrive at a common airport, common terminal, etc., and may further be headed to a common destination (e.g., common hotel). Users may further be grouped based on a time of arrival, flight number, etc. Yet further, users may be grouped based on their ground destination being in a common vicinity (e.g., neighboring hotels). The user-grouping data may be shared by the airline service with the on-demand shuttle service and used to request an on-demand shuttle. For example, the arrival time may be used to schedule an on-demand shuttle pickup time while a number of hotel users arriving on a given flight may be used to request a capacity of a shuttle and/or to request additional shuttles. User-grouping data may also be shared with a hotel service provider.

A specific grouping operation can be coordinated to notify an on-demand shuttle operator if there a delay at the end of a group of users who have requested a pick-up, or for whom a convenient pickup has been scheduled by the hotel service provider and/or airline service provider (e.g., due to a delay in flight arrival or baggage arrival).

Conventional transportation services that operate to and from airports are organized based primarily on capacity, with destination as a secondary consideration. These services typically reserve desk space in the airline terminal where passengers check in and are added to a queue for a shuttle. Once enough passengers arrive to fill the capacity of the shuttle or the maximum waiting time is reached, the shuttle departs. Users on a shuttle may be headed to destinations separated by significant distances, causing users dropped off later in the trip to be delayed and inconvenienced.

The on-demand transportation service may be organized to avoid the inconvenience associated with long waiting times on traditional airport shuttles. By coordinating based on flight schedules and common destinations, the size of the shuttle and number of shuttles can be determined to avoid waiting times associated with the arrival of a sufficient number of customers to utilize a traditional fixed size shuttle capacity. The inconvenience associated with grouping customers originating from different locations or headed to different and disparate destinations is advantageously reduced.

Another disadvantage for passengers considering traditional shuttle services is uncertainty and lack of control. Wait times are not guaranteed when departing from terminals or when being picked up at individual destinations. Once on board, a second uncertainty exists in the time required to pick up or drop off other users, which can induce stress for users facing tight time constraints.

An on-demand shuttle service such as disclosed herein can eliminate these uncertainties by providing a maximum wait time at a station and a maximum allowable distance between passenger pick-ups/drop-offs. These factors can potentially be built into a pricing system of the on-demand transportation service. For example, a passenger who will only accept a wait time of 5 minutes may pay a premium to receive this guarantee. Pricing may also be coupled with other inconvenience factors.

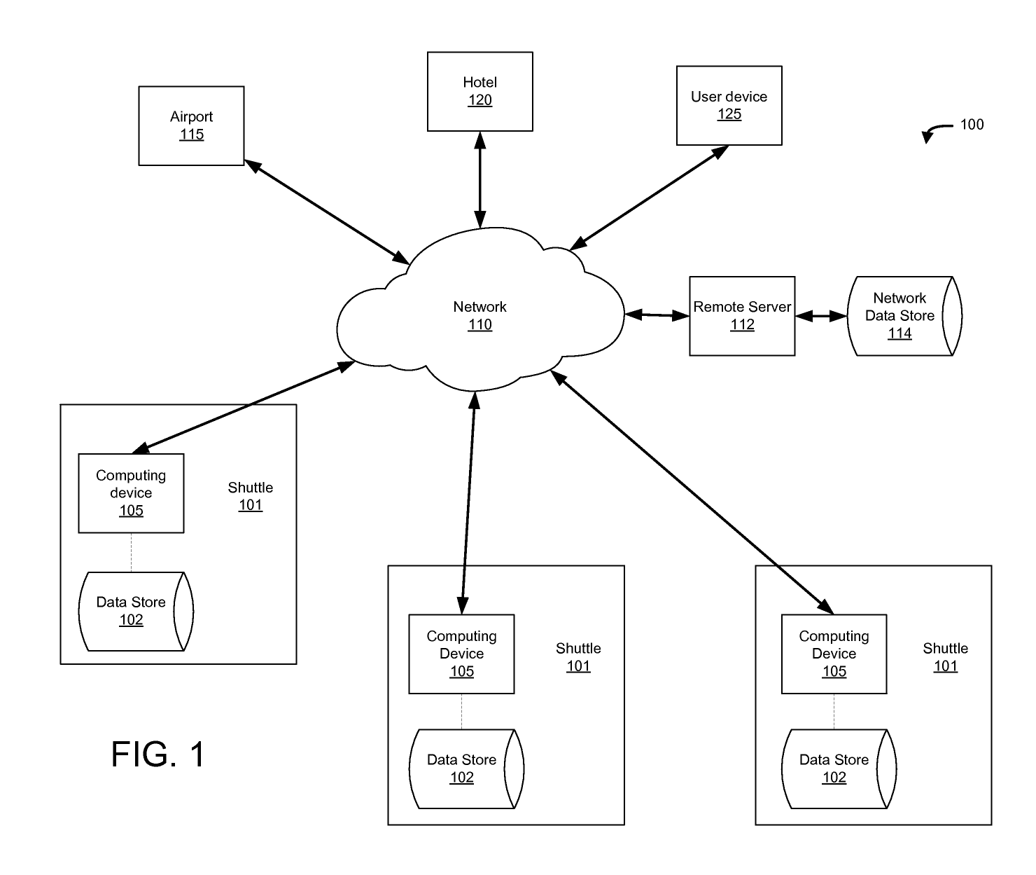

FIG. 1 is a block diagram of an on-demand transportation system 100. The system 100 includes an on-demand transport, e.g. one or more transport vehicles such as shuttles 101. Each shuttle 101 includes a computing device 105 and a data store 102, e.g., one or more memories or media included in or communicatively coupled to the computing device 105. The shuttles 101 may be of any suitable type, e.g., vans, buses, limousines, etc., to accommodate the users.

The computing devices 105 in each respective shuttles 101 communicate via network 110 having a remote server 112, typically including or communicatively coupled to, a network data store 114. An airport 115 and a hotel 120 are also connected, e.g., computing devices associated with such entities are connected, to the network 110. The shuttles 101, the airport 115, and the hotel 120 all send and receive data over the network 110. The network 110 includes one or more known technologies, e.g., the network 110 may include one or more of wireless communication networks (e.g., using Bluetooth, IEEE 802.11, etc.), a cellular network, local area networks (LAN) and/or wide area networks (WAN), including the Internet, etc., providing data communication services.

The data store 102, the remote server 112, and the network data store 114 may be of any suitable type, e.g., hard disk drives, solid-state drives, servers, or any other volatile or non-volatile media. The data store 102 and the network data store 112 may store data sent over the network 110.

One or more user devices 125 (a single device 125 being shown in FIG. 1 for ease of illustration) may be connected to the network 110. The user devices 125 may include commonly-carried devices such as one or more of cellular telephones, tablet devices, laptop computers, etc.

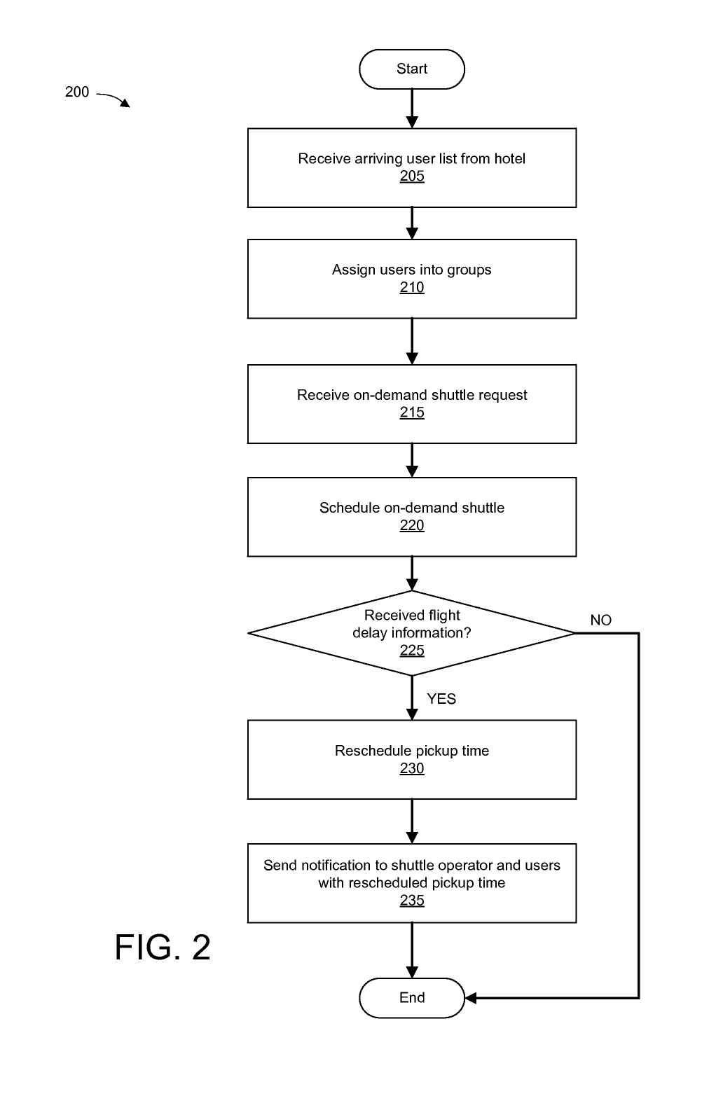

FIG. 2 is a flow diagram of a process 200 for on-demand transportation. Note that some or all of the process 200 is generally carried out according to program instructions executed by the remote server 112 and/or a shuttle 101 computer 105. Alternatively or additionally, operations ascribed herein to the server 112 may be conducted according to program instructions included in a computing device in a hotel 120, airport 115, etc., such device(s) being connected to the network 110.

In a block 205, the computing device 105 receives the list of users, the list typically including additional data concerning attributes of a user and/or user's trip, such as names, flight numbers, arrival times, and/or destinations for the users.

Next, in a block 210, the users are assigned to groups based on one or more criteria relating to the users and or their respective trips. For example, users staying at the same hotel 120 may be placed into a group, or users arriving on the same flight may be placed into a group, or a group could be limited to users on a given flight and also staying at a given hotel. Users could be grouped by various other criteria, including flight arrival time, flight delays, capacity of a shuttle 101, and/or waiting time tolerance, i.e., the maximum amount of time the user is willing to wait for the on-demand shuttle 101.

Next, in a block 215, the computing device 105 in a transportation vehicle such as a shuttle 101 receives a request for transportation from a requestor, the requestor being, e.g., any of the hotel 120, the employees of the hotel 120, the airport 115, the airline service, the shuttle service, or the users. For example, the requestor may be an automated user tracking device at the hotel 120 that requests on-demand shuttles 101 at certain times on days when users are scheduled to arrive.

Next, in a block 220, the remote server 112 schedules one of the on-demand shuttles 101 to go to the airport 115 to receive the users and transport them to their destinations. The computing device 105 calculates a scheduled pickup time, or alternatively or additionally this could be done by the server 112. For example, if one of the groups of users includes only users staying at a single hotel, e.g., the hotel 120, the computing device 105 will plan a route from the airport 115 to the hotel 120. If there are more users in the group than a capacity of the shuttle 101, the remote server 112 will schedule another shuttle 101 to arrive at the airport 115. At this point, the computing device 105 will send a notification to the users, e.g., via devices 125, and the shuttle operator noting the scheduled pickup time, or alternatively or additionally this could be done by the server 112.

The notification may include several kinds of data useful for a user. For example, the notification may include the scheduled pickup time at the airport 115, an estimated arrival time for the users' destination (e.g. the hotel 120), a price or invoice for the shuttle 101, and/or identifying features of the shuttle 101 (e.g. a number or brand name). The notification may be sent in any suitable manner, e.g., by electronic mail, by text message, by social media application, or through a dedicated smartphone application. For example, the users may be more easily grouped using data from social media applications, as social networks are a self-selecting platform for dictating preferences and group size and ensuring those preferences are met.

Next, in a block 225, the computing device 105 determines whether the airport 115 has sent flight delay data. If flight delay data has not been received, the shuttle 101 follows the scheduled pickup time and the process 200 ends.

If flight delay data has been received in the block 225, then a block 230 includes determining if the group includes users whose flight has been delayed. If the group has users whose flight has been delayed, the pickup time is rescheduled to account for the delay.

Next, in a block 235, the newly rescheduled pickup time is sent in a new notification to the shuttle operator and the users and the process 200 ends.

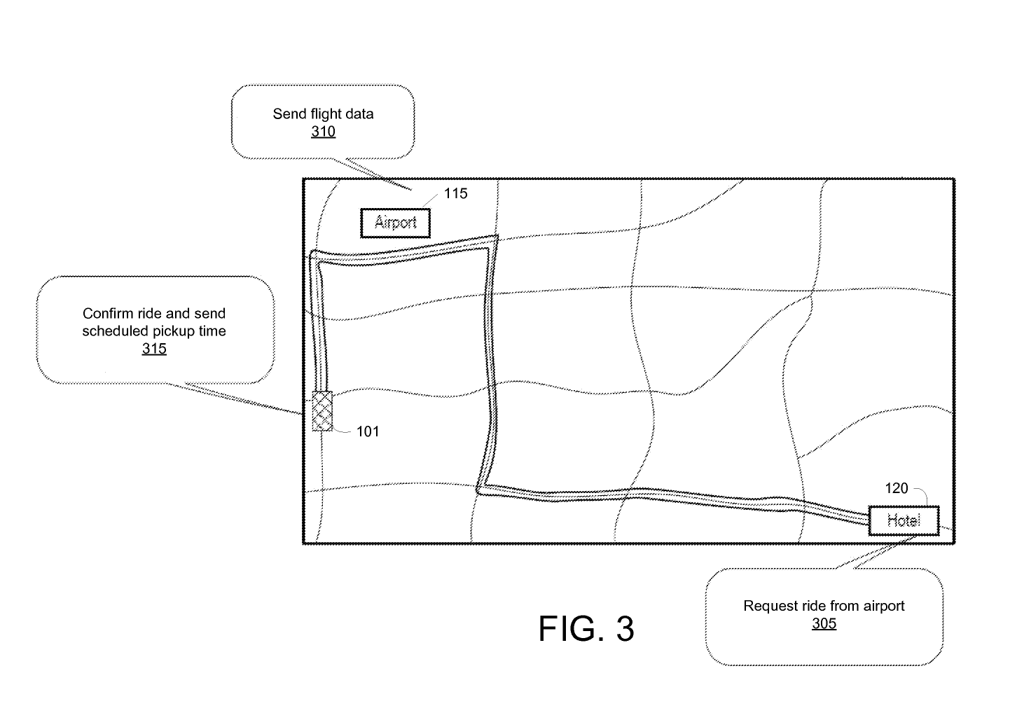

FIG. 3 shows a visual representation of the on-demand transportation system 100 during an example operation. At an operation 305, the hotel 120, e.g., a computing device therein connected to the network 110, requests that an on-demand shuttle 101 pick up the users staying at the hotel 120 from the airport 115. For example, as noted above, the hotel 120 may send a request to the remote server 112. At an operation 310, the airport 115 then sends updated flight data to the shuttle 101, e.g., to a computer 105 therein. At an operation 315, having received data from the airport 115 and the hotel 120, the computing device 105 schedules the pickup time and sends the notification to the users, the airport, and the hotel with the scheduled pickup time, or alternatively or additionally this could be done by the server 112.

In one example, the flight arrival, flight delay, and user data provided by a service provider of the shared transportation service or another service provider such as an airport 115 or hotel 120 may be stored on the data store 114 associated with the remote server 112 on which a fleet managing application for the shuttle 101 may run. The application running on the server may be responsible for scheduling the shuttles 101 based on the received requests and further based on shuttle locations, routes, usage and availability. Alternatively or additionally, grouping data may be uploaded from the hotel 120 or airline database at the airport 115 to the data store 112 associated with the remote server 112 over the network 110.

Computing devices 105 generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A system, comprising:
a computer including a processor and a memory, the memory storing instructions executable by the computer to:
receive data relating to travel of a plurality of users, including destinations of the plurality of users and flight arrival delay data;
assign the plurality of users to a plurality of groups based on the data;
identify, based at least in part on the data, an on-demand transport shareable by a selected group; and
initiate the on-demand transport for the selected group.

2. The system of claim 1, wherein, upon receiving the flight arrival delay data the computer is further programmed to generate the scheduled pickup time by revising a prior scheduled pickup time based on the flight arrival delay data.

3. The system of claim 2, wherein computer is further programmed to send a second notification to users in the selected group, and to an operator of the on-demand transport with the new scheduled pickup time.

4. The system of claim 1, wherein computer is further programmed to receive a request for the on-demand transport.

5. The system of claim 4, wherein computer is further programmed to schedule the on-demand transport is scheduled and the notification including the estimated pickup time is prepared.

6. The system of claim 5, wherein the requestor is one of a hotel service or an airline service.

7. The system of claim 1, wherein the data includes flight arrival times.

8. The system of claim 7, wherein the computer is further programmed to include users with a same arrival time in the selected group.

9. The system of claim 8, wherein the notification includes an estimated destination arrival time individualized for each user in the selected group.

10. The system of claim 1, wherein the notification includes an estimated destination arrival time for at least some of the plurality of users.

11. The system of claim 1, wherein the plurality of groups are determined by at least one of flight arrival time, destination, arrival flight number, and number of users.

12. The system of claim 1, wherein the destination is a hotel, one of the groups includes users who are users of the hotel, and the on-demand transport is a shuttle.

13. The system of claim 1, wherein the instructions include instructions to send a notification to the one of the groups concerning the on-demand transport including a scheduled pickup time for the on-demand transport defined by the flight arrival delays.

14. A method, comprising:
receiving data relating to travel schedules of a plurality of users, including destinations of the plurality of users and flight arrival delays;
assigning the plurality of users to a plurality of groups based on the data;
identifying, based at least in part on some of the data, an on-demand transport Shareable by one of the groups; and
initiating the on-demand transport for the selected group.

15. The method of claim 14, wherein upon receiving the flight arrival delays, if the scheduled pickup time is already determined, the scheduled pickup time is redefined based on the flight arrival delays.

16. The method of claim 15, wherein when the scheduled pickup time is redefined based on the flight arrival delays, a new notification is sent to the group and to an operator of the on-demand transport with the new scheduled pickup time.

17. The method of claim 14, wherein upon identifying the on-demand transport sharable by one of the groups, a requestor at one of the destinations requests the on-demand transport.

18. The method of claim 17, wherein after the requestor requests the on-demand transport, the on-demand transport is scheduled and the notification including the estimated pickup time is prepared.

19. The system of claim 14, wherein the data includes flight arrival times, and one of the groups includes users that have the same flight arrival time.

20. The method of claim 14, further including sending a notification to the one of the groups concerning the on-demand transport including a scheduled pickup time for the on-demand transport defined by the flight arrival delays.
